(19) United States
(12) Patent Application Publication
(10) Pub. No.: US 2017/0036076 A1
(43) Pub. Date: Feb. 9, 2017

(54) FORGED SLOTTED IRON GOLF CLUB

(71) Applicant: Mizuno USA, Inc., Norcross, GA (US)

(72) Inventors: Kazuhiro Doi, Osaka (JP); Tetsuya Kanayama, Osaka (JP); David Llewellyn, Norcross, GA (US); Chris Voshall, Norcross, GA (US)

(21) Appl. No.: 14/820,908

(22) Filed: Aug. 7, 2015

(51) Int. Cl. A63B 53/04; B23K 31/02

(52) U.S. Cl. CPC A63B 53/0475; B23K 31/02; A63B 2053/0491

(57) ABSTRACT

An iron golf club head is disclosed. The iron golf club head can include a hosel portion, a heel portion, a toe portion, a face portion, and a sole portion all forged from a single piece of steel. The iron golf club head can further include a slot cut in the forged club behind the face portion between the heel portion and the toe portion. The slot can have a sole opening and a cavity opening, and a plug can be located in the sole opening.

### BACKGROUND OF THE INVENTION

Field of the Invention

The present invention relates to an iron golf club head and an iron golf club, and more specifically to a forged iron golf club head having a slot cut behind the face.

Description of the Background Art

There are many qualities of a golf club that a golfer uses to assess its quality and performance. Two such attributes that are relatively easy to evaluate for a player are the sound and feel of the ball striking, and the flight distance of the ball.

It is generally accepted at the ultimate method of production when it comes to feel is forging. By forging a golf club, a manufacturer is able to ensure greater consistency from piece to piece and an improved internal consistency of the club. The forging process also avoids the issue of “pin holes” that exist as an artifact of the alternative casting process. These pin holes lead to less consistent vibrations, and this affects the feel of the club.

A forged product will also have a longer grain structure in the metal which will affect the overall duration of vibration. The longer grain structure of a forged iron is known to produce more consistent and desired vibrations and sounds that help provide feedback to the golfer. These characteristics of forged clubs have long been the reasons that the majority of experienced and well accomplished golfers have leaned towards playing forged irons.

While the term “forging” has been used extensively in the golf industry, its use has been associated with many different degrees and arrangements of clubs. Typically, as long as a single piece of the clubs is forged, many manufacturers will call the club forged. This means that many clubs marketed as “forged” are only partially created using a forging process. This limited use of forging drastically limits many of the feel and consistency benefits of the process.

The ideal club design for vibration and feel purposes would be a single forged piece, with no cast elements attached thereto. A single piece forging will have the most true vibrations and also the most consistent vibrations because each additional piece which is added (either through welding, brazing, or some other method of adhesion) introduces another level of tolerances for inconsistencies as well as additional vibration dampening caused by non-continuous grains.

Along with feel, another goal in club design is to increase the coefficient of restitution (“COR”) of the club face. An iron with a high COR will generate faster ball speeds. One of the keys to increasing the COR is generally to increase the area of thinner portions of the face.

A club with a thin face is traditionally difficult to achieve when using the forging process. The limitations on the forging process include requirements as to draft angles and minimum thicknesses to avoid forging defects. These limitations have pushed club manufacturers to compromise club feel for ease of manufacturing. Some manufacturers have created combinations such as having a forged hosel and face portion welded to a cast back portion or having a forged club body and hosel welded to a maraging steel face portion.

What is needed, therefore, is a club head that maintains a high percentage of forged construction, while also having the high COR that results from having a club face with thin areas. It is to such a golf club that embodiments of the present invention are primarily directed.

### SUMMARY OF THE INVENTION

The present invention addresses the above issue, and contemplates an iron golf club head that can provide an enhanced club feel while maintaining a high COR.

In some embodiments, an iron golf club head can comprise a hosel portion, a heel portion, a toe portion, a face portion, and a sole portion forged from a single piece of steel. Embodiments according to the present disclosure can include a slot disposed behind the face portion between the heel portion and the toe portion, with the slot having a sole opening and a cavity opening. In some embodiments, a plug is located in the sole opening.

In some embodiments, the plug can be a piece of metal welded over the sole opening to create a substantially continuous sole surface. The plug can also be a plastic insert that is press-fit into the sole opening. Embodiments according to the present disclosure may be made such that the weight of the plug is less than about 10% of the weight of the entire iron golf club head.

In some embodiments, the club head further includes a cavity plug in the cavity opening. The cavity plug may be a plastic insert that can be press-fit into the cavity opening.

Embodiments according to the present disclosure may also relate to a method for making an iron golf club head. In some embodiments, such a method can include forging a hosel portion, a heel portion, a toe portion, a face portion, and a sole portion from a single piece of steel. In some embodiments, the method may include cutting a slot behind the face portion between the heel portion and the toe portion, with the slot having a sole opening and a cavity opening. A method according to the present disclosure can include plugging the sole opening.

In some embodiments, the step of plugging the sole opening may also include providing a plug made of a piece of metal, welding the plug over the sole opening, and sanding the sole portion of the iron golf club head to create a substantially continuous sole surface. In some embodiments, the step of plugging the sole opening may include providing a plug made of plastic, and press-fitting the plug into the sole opening.

In some embodiments, the method may include plugging the cavity opening in addition to the sole opening. The step of plugging the cavity opening may include providing a cavity plug made of plastic, and press-fitting the plug into the cavity opening.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view of an iron golf club according to an embodiment of the present invention.

FIG. 2 is a perspective view of an iron golf club according to an embodiment of the present invention that illustrates the slot in dashed lines.

FIG. 3 is a cross-section of an iron golf club taken along a line 3-3 shown in FIG. 1.

FIG. 4 is a cross-section of an iron golf club taken along a line 3-3 shown in FIG. 1 according to an embodiment of the present invention that includes a welded plug.

FIG. 5 is a cross-section of an iron golf club taken along a line 3-3 shown in FIG. 1 according to an embodiment of the present invention that includes plastic plugs in the slot.

### DETAILED DESCRIPTION

Embodiments of the present invention relate generally to golf clubs, and more particularly to forged iron golf clubs. In some embodiments, a club according to the current disclosure may be over 90% forged by weight. This design allows for more of the benefits of forging, without the downsides associated with a low-COR striking face. The resulting club has a high-COR, comparable with or better than other commercially available “forged” clubs, but also has an improved feel due to its increased percentage of forged construction.

To simplify and clarify explanation, the invention is described herein as a slotted iron golf club. One skilled in the art will recognize, however, that the invention is not so limited.

The materials described hereinafter as making up the various elements of the present invention are intended to be illustrative and not restrictive. Many suitable materials that would perform the same or a similar function as the materials described herein are intended to be embraced within the scope of the invention. Such other materials not described herein can include, but are not limited to, materials that are developed after the time of the development of the invention.

As described above, a general problem with so-called “forged” golf clubs is that they are only forged in some small part, and thus can't fully reap the benefits of the long grain associated with the forging process. The present invention according to an embodiment is thus useful in that it can provide an iron golf club head with improved feel, which possesses a high COR.

Although the present invention has been described and illustrated in detail, it is clearly understood that the same is by way of illustration and example only and is not to be taken by way of limitation, the scope of the present invention being interpreted by the terms of the appended claims.

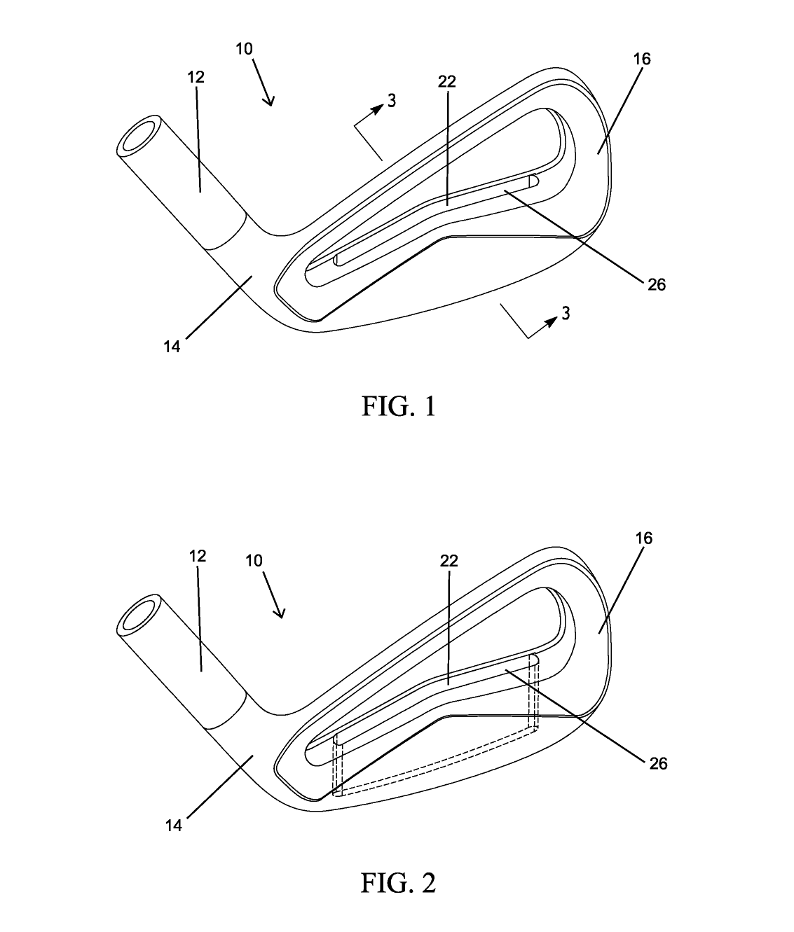

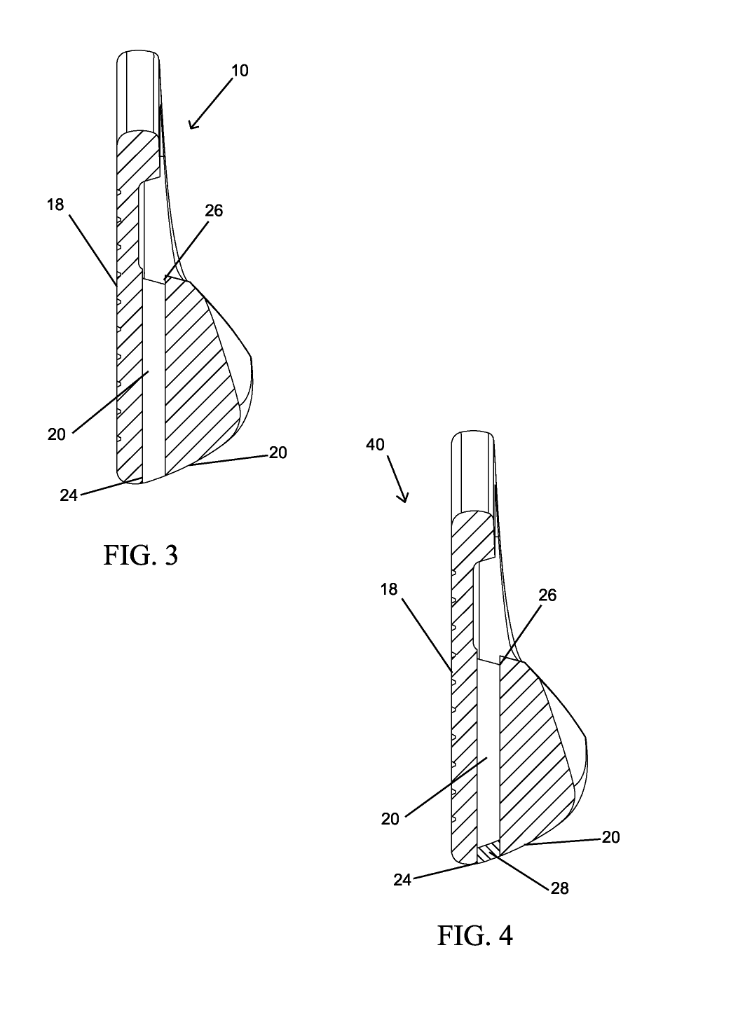

In some embodiments, as shown in FIGS. 1-3, an iron golf club head 10 is provided with a hosel portion 12, a heel portion 14, a toe portion 16, a face portion 18, and a sole portion 20. To provide the club with a higher-COR, a slot 22 is cut behind face portion 18 and having a sole opening 24 and a cavity opening 26. Slot 22 allows face portion 18 to have a larger thin area than a club that has been made with only traditional forging.

As shown in FIG. 4, embodiments of an iron golf club head 40 according to the present disclosure may have plug 28 disposed in the sole opening end of slot 22. Plug 28 may be a piece of steel that is welded or otherwise secured into place in sole opening 24. Once plug 28 is secured, sole portion 20 may be sanded and polished so as to leave no protruding edges to cause undesired turf interaction.

Plugs such as that depicted in FIG. 4 may be of several different water resistant materials of suitable durability. In some embodiments, other metals such as tungsten could be used to add weight and move the center of gravity of the club towards the sole. Other embodiments may use a lighter material such as an epoxy or a metal such as aluminum. The selection of the density and volume of material used may be made based on providing a desired center of gravity for the club head.

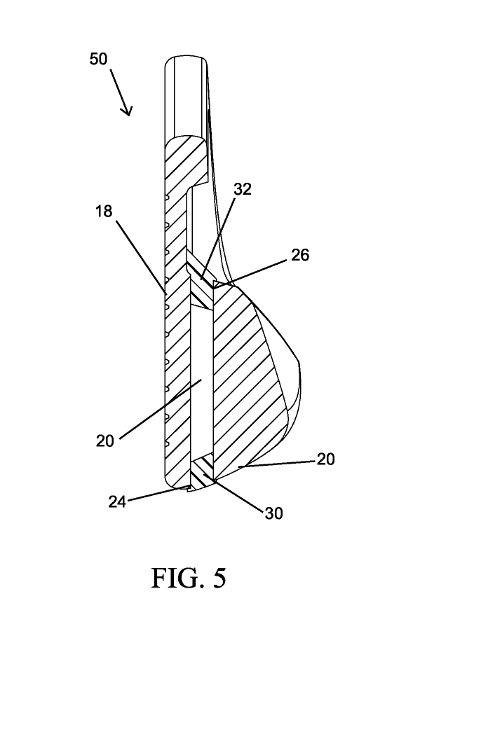

As shown in FIG. 5, embodiments of an iron golf club head 50 may have plugs 30 and 32 made of a plastic or rubberized material. Plugs 30 and 32 may be press fit into sole opening 24 and/or cavity opening 26. In some embodiments, plugs 30 and 32 may be secured by other reasonable means such as glues or epoxies.

Some embodiments in accordance with the present disclosure may have a mix of metal welded and press-fit plugs. The plugs serve to eliminate undesired turf interactions as well as to prevent moisture or debris entering slot 22. If slot 22 has moisture or debris in it, there may be corrosion or other adverse effects on the club's performance or durability.

While several possible embodiments are disclosed above, embodiments of the present invention are not so limited. For instance, while several possible configurations have been disclosed (e.g., embodiments with a single slot, or a slot with two plugs), other suitable slot configurations and plugs could be selected without departing from the spirit of embodiments of the invention. In addition, the location and configuration used for various features of embodiments of the present invention can be varied according to a particular golf club that requires a slight variation due to, for example, the size or construction of the golf club, the user, or cost issues. Such changes are intended to be embraced within the scope of the invention.

The specific configurations, choice of materials, and the size and shape of various elements can be varied according to particular design specifications or constraints requiring a device, system, or method constructed according to the principles of the invention. Such changes are intended to be embraced within the scope of the invention. The presently disclosed embodiments, therefore, are considered in all respects to be illustrative and not restrictive. The scope of the invention is indicated by the appended claims, rather than the foregoing description, and all changes that come within the meaning and range of equivalents thereof are intended to be embraced therein.

1. An iron golf club head, comprising:
a hosel portion, a heel portion, a toe portion, a face portion, and a sole portion, wherein the hosel portion, heel portion, toe portion, face portion, and sole portion are all forged from a single piece of steel;
a slot disposed behind the face portion between the heel portion and the toe portion, the slot having a sole opening and a cavity opening; and
a plug located in the sole opening.

2. The iron golf club head of claim 1, wherein the plug comprises a metal welded over the sole opening to create a substantially continuous sole surface.

3. The iron golf club head of claim 2, wherein the metal is steel.

4. The iron golf club head of claim 2, wherein the metal is tungsten.

5. The iron golf club head of claim 1, wherein the plug comprises a plastic insert that is press-fit into the sole opening.

6. The iron golf club head of claim 1, wherein the weight of the plug is less than about 10% of the weight of the entire iron golf club head.

7. The iron golf club head of claim 1, the club head further comprising a cavity plug in the cavity opening.

8. The iron golf club head of claim 5, wherein the cavity plug comprises a plastic insert that is press-fit into the cavity opening.

9. A method for making an iron golf club head, comprising the steps of:
forging a hosel portion, a heel portion, a toe portion, a face portion, and a sole portion from a single piece of steel;
cutting a slot behind the face portion between the heel portion and the toe portion, the slot having a sole opening and a cavity opening; and
plugging the sole opening.

10. The method of claim 9, wherein the step of plugging the sole opening further comprises:
providing a plug, wherein the plug comprises a metal;
welding the plug over the sole opening; and
sanding the sole portion of the iron golf club head to create a substantially continuous sole surface.

11. The method of claim 10, wherein the metal is steel.

12. The method of claim 10, wherein the metal is tungsten.

13. The method of claim 9, wherein the step of plugging the sole opening further comprises:
providing a plug, wherein the plug comprises a plastic insert; and
press-fitting the plug into the sole opening.

14. The method of claim 9, wherein the weight of the plug is less than about 10% of the weight of the entire iron golf club head.

15. The method of claim 9, further comprising the step of:
plugging the cavity opening.

16. The method of claim 15, wherein the step of plugging the cavity opening further comprises:
providing a cavity plug, wherein the cavity plug comprises a plastic insert; and
press-fitting the plug into the cavity opening.
